(19) United States
(12) Patent Application Publication
(10) Pub. No.: US 2022/0350188 A1
(43) Pub. Date: Nov. 3, 2022

(54) LIGHT CONTROL FILM

(71) Applicant: AISIN CORPORATION, Kariya (JP)

(72) Inventors: Akira KUSAKABE, Kariya-shi (JP); Kaoru SHIMANO, Kariya-shi (JP)

(73) Assignee: AISIN CORPORATION, Kariya (JP)

(21) Appl. No.: 17/728,146

(22) Filed: Apr. 25, 2022

(30) Foreign Application Priority Data
Apr. 30, 2021 (JP) 2021-077010

(51) Int. Cl. G02F 1/1343; G02F 1/1334; E06B 9/24

(52) U.S. Cl. CPC G02F 1/13439; G02F 1/134309; G02F 1/1334; E06B 9/24; E06B 2009/2464

(57) ABSTRACT

A light control film includes a light control layer containing a material in which transmittance of electromagnetic waves changes when a voltage is applied, a first electrode layer and a second electrode layer that are respectively stacked on both sides of the light control layer and are configured such that the voltage is applicable to the light control layer, a substantially transparent first base material layer that is stacked on a side of the first electrode layer opposite to the light control layer and supports the first electrode layer, and a substantially transparent second base material layer that is stacked on a side of the second electrode layer opposite to the light control layer and supports the second electrode layer. At least one of the first electrode layer and the second electrode layer is a conductive DLC layer.

### CROSS REFERENCE TO RELATED APPLICATIONS

This application is based on and claims priority under 35 U.S.C. § 119 to Japanese Patent Application 2021-077010, filed on Apr. 30, 2021, the entire content of which is incorporated herein by reference.

### TECHNICAL FIELD

This disclosure relates to a light control film in which transparency changes when a voltage is applied.

### BACKGROUND DISCUSSION

Research report of Asahi Glass Co. Ltd. 65 (2015), pages 10 to 14 (Non-patent Reference 1) discloses a light control film configured such that transparency (in other words, transmittance of light or degree of cloudiness) can be changed. Specifically, this light control film includes a polyethylene terephthalate film with two conductive films (transparent electrodes) and a matrix polymer in which liquid crystal molecules intervening between the two films are dispersed. When no voltage is applied to the matrix polymer in which the liquid crystal molecules are dispersed, the light is scattered by the liquid crystal, and thus the light control film shows a milky white appearance. On the other hand, when a voltage is applied, the liquid crystals are aligned, such that the light control film is almost transparent.

Nevertheless, it is required that the light control film has a heat shielding function and a function of adjusting color of transmitted light (hereinafter, referred to as color adjusting function). In order to impart these functions to the light control film, for example, a structure is considered in which a heat shielding film and a colored film (filter) are attached to the light control film. However, in the structure in which the heat shielding film and the colored film are attached to the light control film, the heat shielding film and the colored film have thicknesses, and thus the light control film becomes thicker when the heat shielding film and the colored film are attached. For example, as shown in JP 2017-187810A (Reference 1), an intermediate layer that functions as an adhesive layer is formed, and the light control film thus becomes thicker due to the formation of the intermediate layer. For this reason, it becomes difficult to attach the light control film to an object having a curvature. In the production of the light control film, a step of attaching these films is required. Thus, the man-hours in the production increase and the production cost increases. In addition, Non-patent Reference 1 discloses a structure in which an infrared ray-cutting coating is applied to a window glass for vehicles to which the light control film is applied such that the window glass has the heat shielding function. However, Non-patent Reference 1 does not disclose a structure for imparting the heat shielding function and the color adjusting function to the light control film.

A need thus exists for a light control film which is not susceptible to the drawback mentioned above.

### SUMMARY

According to an aspect of this disclosure, a light control film includes:

a light control layer containing a material in which transmittance of electromagnetic waves changes when a voltage is applied;

a first electrode layer and a second electrode layer that are respectively stacked on both sides of the light control layer and are configured such that the voltage is applicable to the light control layer;

a substantially transparent first base material layer that is stacked on a side of the first electrode layer opposite to the light control layer and supports the first electrode layer; and

a substantially transparent second base material layer that is stacked on a side of the second electrode layer opposite to the light control layer and supports the second electrode layer, in which

at least one of the first electrode layer and the second electrode layer is a conductive DLC layer.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view schematically showing a structure of a light control film;

FIG. 2 is a diagram showing a method of producing the light control film;

FIG. 3 is a graph showing results of spectroscopic measurements; and

FIG. 4 is a graph showing experimental results of difficulty of peeling off a first electrode layer.

### DETAILED DESCRIPTION

Hereinafter, an embodiment disclosed here will be described. In the embodiment disclosed here, “light” includes not only visible light but also electromagnetic waves in a wavelength range other than visible light such as infrared rays.

### Structure of Light Control Film

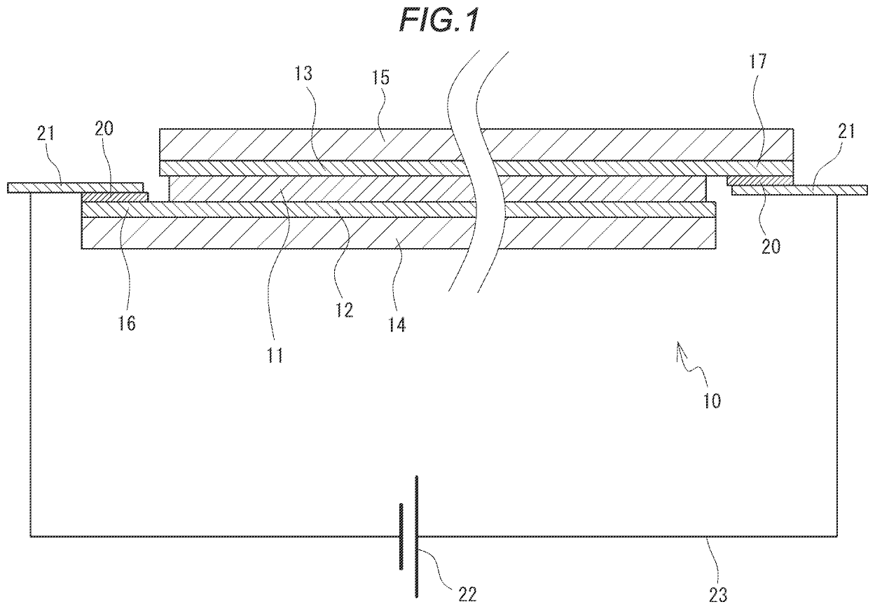

FIG. 1 is a cross-sectional view schematically showing a structure of a light control film 10 according to the embodiment. As shown in FIG. 1, the light control film 10 includes a light control layer 11, a first electrode layer 12, a second electrode layer 13, a first base material layer 14, and a second base material layer 15. The first electrode layer 12 is stacked on one surface of the light control layer 11, and the second electrode layer 13 is stacked on a surface opposite to the one surface. That is, the light control layer 11 is sandwiched between the first electrode layer 12 and the second electrode layer 13. The first base material layer 14 is stacked on a surface of the first electrode layer 12 on a side opposite to the side stacked on the light control layer 11. The second base material layer 15 is stacked on a surface of the second electrode layer 13 on a side opposite to the side stacked on the light control layer 11.

The light control layer 11 is a layer in which the degree of cloudiness (which can also be referred to as transparency or light transmittance) changes when a voltage is applied. Specifically, the light control layer 11 is cloudy (opaque) when no voltage is applied, and is substantially transparent when the voltage is applied. A polymer-dispersed liquid crystal is applied to the light control layer 11. When no voltage is applied to the polymer-dispersed liquid crystal, an orientation vector of the liquid crystal is irregular, and thus light is diffusely reflected at an interface between the polymer matrix and the liquid crystal. Thus, the polymer-dispersed liquid crystal appears cloudy (that is, becomes opaque white) when no voltage is applied. On the other hand, when the voltage is applied to the polymer-dispersed liquid crystal, the orientation vector of the liquid crystal becomes parallel to lines of electric force, and as a result, the refractive indexes of the polymer matrix and the liquid crystal become almost equal. Thus, the polymer-dispersed liquid crystal becomes substantially transparent when the voltage is applied. In the embodiment, an ultraviolet curable polymer is applied to the polymer of the polymer-dispersed liquid crystal. However, the type of liquid crystal and the type of polymer of the polymer-dispersed liquid crystal are not particularly limited, and various known liquid crystals and polymers in the related art can be applied.

The first electrode layer 12 and the second electrode layer 13 are layers for applying the voltage to the light control layer 11, both of which are translucent and conductive layers. The first electrode layer 12 and the second electrode layer 13 are both stacked on the entire region (entire surface) of the light control layer 11.

A conductive diamond-like carbon (hereinafter, referred to as “DLC”) is applied to the first electrode layer 12. The type of the conductive DLC is not particularly limited. The DLC is dark brown, looks brown when the DLC is thin, and looks almost black when the DLC is thick. The light-shielding property of the DLC increases as the thickness increases (the light transmittance decreases). For this reason, the thickness of the first electrode layer 12 (that is, the thickness of the conductive DLC) is appropriately set according to the function of the light control film 10 (in other words, the use of the light control film 10) and the like.

Indium tin oxide (hereinafter, referred to as “ITO”) is applied to the second electrode layer 13. However, a material other than the ITO may be applied to the second electrode layer 13. In short, the second electrode layer 13 may be a layer having substantially transparency or translucency and having conductivity.

In the embodiment, the first electrode layer 12 is a conductive DLC layer, and although the structure is shown in which the second electrode layer 13 is an ITO layer, both the first electrode layer 12 and the second electrode layer 13 may be the conductive DLC layers. In short, at least one of the first electrode layer 12 and the second electrode layer 13 may be the conductive DLC layer. In a structure in which both the first electrode layer 12 and the second electrode layer 13 are the conductive DLC layers, the overall light transmittance of the light control film 10 depends on a total value of the thickness of the first electrode layer 12 and the thickness of the second electrode layer 13. Thus, in a structure in which both the first electrode layer 12 and the second electrode layer 13 are the conductive DLC layers, the total value of the thicknesses of the first electrode layer 12 and the second electrode layer 13 is set according to the function of the light control film 10.

The first base material layer 14 is a layer that supports the first electrode layer 12, and the second base material layer 15 is a layer that supports the second electrode layer 13. The first base material layer 14 and the second base material layer 15 are both colorless and transparent layers and are formed of a material having electrical insulating properties and flexibility. In the embodiment, a polyethylene terephthalate (PET) film (sheet) is applied to the first base material layer 14 and the second base material layer 15. The thicknesses of the first base material layer 14 and second base material layer 15 are not particularly limited, and are appropriately set according to the use of the light control film 10 and the like. Further, an ultraviolet absorber, a stabilizer, or the like may be added to the polyethylene terephthalate. Further, the material of the first base material layer 14 and the second base material layer 15 is not limited to the polyethylene terephthalate, and various colorless and transparent resin materials (organic materials) such as polyimide (PI) and polyethylene naphthalate (PEN) may be applied. Further, an inorganic material such as glass may be applied to the first base material layer 14 and the second base material layer 15.

The light control film 10 is provided with a first electric power feeding unit 16 and a second electric power feeding unit 17 to which wiring members such as a flexible wiring board (FPC) 21 and a wiring cord can be connected. In FIG. 1, a structure in which the FPC 21 is connected to the first electric power feeding unit 16 and the second electric power feeding unit 17 respectively is shown as an example. The first electric power feeding unit 16 and the second electric power feeding unit 17 are portions for electrically connecting each of the first electrode layer 12 and the second electrode layer 13 to an external power supply 22. The first electric power feeding unit 16 is a portion of the first electrode layer 12 in which the light control layer 11, the second electrode layer 13, and the second base material layer 15 are not stacked (in other words, the portion exposed without being covered with the light control layer 11, the second electrode layer 13, and the second base material layer 15). The second electric power feeding unit 17 is a portion of the second electrode layer 13 in which the light control layer 11, the first electrode layer 12, and the first base material layer 14 are not stacked (in other words, the portion exposed without being covered with the light control layer 11, the first electrode layer 12, and the first base material layer 14).

Moreover, since the FPC 21 is connected to the first electric power feeding unit 16 and the second electric power feeding unit 17 respectively with a conductive adhesive 20 or the like, and the FPC 21 and the external power supply 22 are electrically connected with a wiring cord 23 or the like, a voltage can be applied to the light control layer 11 by the first electrode layer 12 and the second electrode layer 13. If no voltage is applied to the light control layer 11, the light control layer 11 is in a cloudy state, and thus the light control film 10 becomes opaque. On the other hand, when the voltage is applied to the light control layer 11 by the first electrode layer 12 and the second electrode layer 13, the light control layer 11 becomes substantially transparent, and thus the light control film 10 becomes colored transparent having the color of the first electrode layer 12 (that is, the color of the DLC). In this way, by switching between the state in which the voltage is not applied to the light control layer 11 and the state in which the voltage is applied to the light control layer 11 by the first electrode layer 12 and the second electrode layer 13, the light control film 10 can be switched between the opaque state and the colored transparent state.

The DLC has a lower infrared transmittance than the ITO used as an electrode layer (transparent electrode) of a related-art light control film. Thus, by applying the conductive DLC to at least one of the first electrode layer 12 and the second electrode layer 13, at least one of the first electrode layer 12 and the second electrode layer 13 can have the heat shielding function. In other words, it is possible to provide the light control film 10 with the heat shielding function without attaching a heat shielding film to the light control film 10 (in other words, without using a heat shielding film that is separate from the first base material layer 14, the second base material layer 15, the first electrode layer 12, the second electrode layer 13, and the light control layer 11). Thus, the light control film 10 can be made thinner than the structure in which the heat shielding film is attached. For this reason, such a light control film 10 is easier to be attached to an object having a curvature (for example, curved glass) as compared with the light control film to which the heat shielding film is attached.

The DLC is dark brown. For this reason, by applying the conductive DLC to at least one of the first electrode layer 12 and the second electrode layer 13, it is possible to provide the light control film 10 with the color adjusting function without attaching the colored film to the light control film 10 (in other words, without using a colored film that is separate from the first base material layer 14, the second base material layer 15, the first electrode layer 12, the second electrode layer 13, and the light control layer 11). Thus, the light control film 10 can be made thinner than the structure in which the colored film is attached. For this reason, such a light control film 10 is easier to be attached to an object having a curvature as compared with the light control film to which the colored film is attached.

Since the first electrode layer 12 has the color adjusting function, it is possible to provide the light control film 10 with the color adjusting function without using colored materials for the first base material layer 14 and the second base material layer 15. For this reason, a widely used colorless and transparent material can be applied to the first base material layer 14 and the second base material layer 15. Thus, it is possible to prevent or suppress an increase in the price of the light control film 10.

Here, an example of the thickness of the conductive DLC layer will be described. As the thickness of the conductive DLC layer, a thickness in the range of 0.05 μm or more and 0.3 μm or less can be applied. When the thickness of the conductive DLC layer is in this range, the parallel transmittance of the conductive DLC layer is about 3% to about 40%. Applications of such a light control film include a light control film applied to shaded outdoor daylighting glass. Examples of the outdoor daylighting glass include glass for sunroofs of vehicles and buildings.

In addition, the thickness of the conductive DLC layer can be in the range of more than 0.3 μm and 0.5 μm or less. When the thickness of the conductive DLC layer is in this range, the parallel transmittance of the conductive DLC layer is about 1% to about 3%, and the transmitted light is dark and blurred. Applications of such a light control film include, for example, a light control film applied to shadeless outdoor daylighting glass.

If the conductive DLC is applied to the first electrode layer 12 and the ITO is applied to the second electrode layer 13 (the conductive DLC is not applied to the second electrode layer 13), the thickness of the conductive DLC layer may be in the above range. If the conductive DLC is applied to both the first electrode layer 12 and the second electrode layer 13, the total value of the thicknesses of the first electrode layer 12 and second electrode layer 13 may be in the above range. However, the above thickness is an example, and the thickness of the conductive DLC layer in this disclosure is not limited to the above thickness. The thickness of the conductive DLC layer is appropriately set according to the application of the light control film 10 (in other words, the function required for the light control film 10).

### Method for Producing Light Control Film

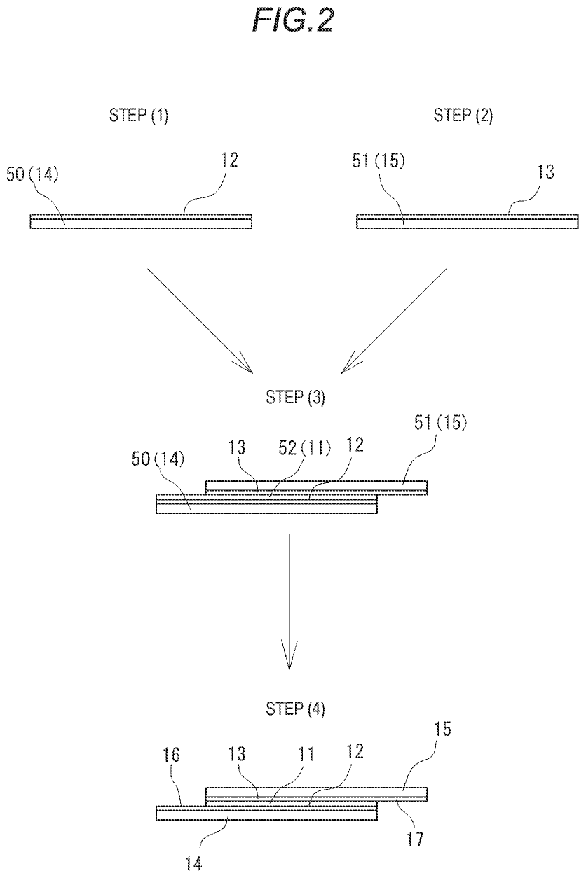

Next, a method for producing the light control film 10 will be described. FIG. 2 is a schematic diagram showing a method of producing a light control film. As shown in FIG. 2, the method of producing the light control film 10 includes: (1) a step of forming the conductive DLC layer, which is the first electrode layer 12, on a surface of a film 50, which is the material of the first base material layer 14, (2) a step of forming the ITO layer, which is the second electrode layer 13, on a surface of a film 51, which is a material of the second base material layer 15, (3) a step of attaching the film 50 that has undergone the step (1) and the film 51 that has undergone the step (2) in a state where a material 52 (a mixture of an unpolymerized resin and a liquid crystal) of the light control layer 11 is filled between the film 50 and the film 51, and then curing the material 52 of the light control layer 11, and (4) a step of forming the first electric power feeding unit 16 and the second electric power feeding unit 17.

A CVD method, a PVD method, or the like can be applied to the step (1). The CVD method is a method of using a hydrocarbon gas such as acetylene gas as a raw material gas, gas-phase synthesizing the hydrocarbon by turning the raw material gas into plasma in a chamber, and vapor-depositing the vapor-phase synthesized hydrocarbon on a surface of a predetermined material (in the embodiment, the film 50 which is the material of the first base material layer 14). The PVD method is a method of exposing, a graphite, which is a raw material of the DLC, to an ion beam or the like in a vacuum to scatter carbon atoms, and moving the scattered carbon atoms by an electric field to adhere the scattered carbon atoms to the surface of the predetermined material. Since both the CVD method and the PVD method are known methods, the description thereof will be omitted.

In addition, a method that combines the CVD method and the PVD method can also be applied to the step (1). Specifically, a method of using a hydrocarbon gas such as acetylene gas as a raw material gas, gas-phase synthesizing the hydrocarbon by turning the raw material gas into plasma in a chamber, and moving the vapor-phase synthesized hydrocarbon by an electric field to adhere vapor-phase synthesized hydrocarbon to the surface of a predetermined material (the film 50 which is the material of the first base material layer 14) can be applied. In this case, the conductive DLC layer can be formed by doping a predetermined impurity element (for example, nitrogen). Further, a method of activating the surface of the film 50, which is the material of the first base material layer 14, by maintaining the inside of the chamber at a predetermined temperature, and increasing a bond strength between the DLC and the surface of the first base material layer 14 (film 50) can be applied.

A known method in the related art can also be applied to the step (2). For example, the CVD method and the PVD method can also be applied to the step (2).

In the step (3), first, the material 52 of the light control layer 11 which is the mixture of the unpolymerized resin (ultraviolet curable resin) and the liquid crystal is dropped on the surface of the conductive DLC layer stacked on the surface of the film 50 (the film which is the material of the first base material layer 14) that has undergone the step (1), and the dropped mixture is leveled with a roller. This forms a layer of the material 52. Next, the film 51 (the film which is the material of the second base material layer 15) that has undergone the step (2) is bonded to a surface of the material 52 such that the ITO layer is in contact with the material 52. The unpolymerized resin is polymerized by irradiating the material 52 with ultraviolet rays. As a result, the polymer-dispersed liquid crystal which is the light control layer 11 is generated.

In the step (4), the light control layer 11 stacked on a predetermined portion of the first electrode layer 12 is removed. If there is a light control layer 11 stacked on a predetermined portion of the second electrode layer 13, this light control layer 11 is also removed. In this step, the light control layer 11 is removed by rubbing the light control layer 11 with a cloth impregnated with an organic solvent, for example. As a result, the predetermined portion of the first electrode layer 12 is exposed to form the first electric power feeding unit 16. The predetermined portion of the second electrode layer 13 is exposed to form the second electric power feeding unit 17.

In the step (4), when the light control layer 11 stacked on the first electrode layer 12 is removed, if the first electrode layer 12 is removed together with the light control layer 11, the first electric power feeding unit 16 cannot be formed. In the embodiment, the conductive DLC is applied to the first electrode layer 12. The DLC is harder (higher wear resistance) than the ITO used for related-art electrodes and difficult to dissolve in organic solvents. Thus, in the step (4), the peeling of the first electrode layer 12 from the first base material layer 14 is prevented or reduced. Further, when forming the conductive DLC layer on the surface of the film which is the material of the first base material layer 14, by heating the film, the surface of the film is activated and a bonding force with the DLC is increased. Thus, with such a structure, an effect of preventing or reducing the peeling of the first electrode layer 12 from the first base material layer 14 can be enhanced.

In the embodiment, the ITO is applied to the second electrode layer 13. However, even with such a structure, when the light control layer 11 stacked on the predetermined portion of the second electrode layer 13 by irradiating the ultraviolet rays from a side of the first base material layer 14 is present in the step (3), a bonding force between the second electrode layer 13 and the light control layer 11 can be weaker than a bonding force between the first electrode layer 12 and the light control layer 11. Thus, according to such a structure, when the light control layer 11 stacked on the second electrode layer 13 is removed to form the second electric power feeding unit 17, it is possible to prevent or reduce the peeling of the second electrode layer 13 from the second base material layer 15.

### Examples

### (Sample)

A sample shown in FIG. 1 to which the conductive DLC was applied to the first electrode layer 12 was produced. A polyimide film was applied to the first base material layer 14 and the second base material layer 15, and an ITO was applied to the second electrode layer 13. For the formation of the first electrode layer 12, a method combining the above-described CVD method and PVD method was used. A sample A, a sample B, and a sample C having different thicknesses of the first electrode layer 12 and formation conditions (heating temperature of the film used as the material of the first base material layer 14) were produced. Table 1 is a table showing the thickness of the first electrode layer 12 of each sample.

TABLE 1
Thickness of First Electrode Layer

| Sample | Sample A | Sample B | Sample C |
|---|---|---|---|
| Thickness of first electrode | 0.25 | 0.15 | 0.05 |
| layer (μm) | | | |

### (Confirmation of Light Control Function)

The inventor measured haze, total light transmittance (Tt), diffusion transmittance (Td), and parallel transmittance (Tp) in a state where no voltage was applied to the light control layer 11 and a state where a voltage was applied to the light control layer 11 relating to the produced sample and the samples (sample D, sample E and sample F) of comparative examples (related-art examples). The sample D, the sample E, and the sample F according to the comparative examples are light control films in which the ITO is applied to the first electrode layer 12 and the second electrode layer 13, and are light control films having a related-art structure (commercial item). Specifically, the sample D, the sample E, and the sample F according to the comparative examples are normal mode light control films that become transparent when the voltage is applied.

Table 2 shows measurement results. The applied voltage is an AC voltage of 100 V and 60 Hz. The sample A according to the example was not measured because the color of the first electrode layer 12 was dark and the light transmittance was low.

TABLE 2
Confirmation of Light Control Function

| | Sample | | | | | | | | | |
|---|---|---|---|---|---|---|---|---|---|---|
| | Sample B | | Sample C | | Sample D | | Sample E | | Sample F | |
| Voltage | OFF | ON | OFF | ON | OFF | ON | OFF | ON | OFF | ON |
| Haze | 84.2 | 16.9 | 88.7 | 18.6 | 94.9 | 17.7 | 95.3 | 7.9 | 95.3 | 7.1 |
| Tt | 18.3 | 17.6 | 34.1 | 33.1 | 87.3 | 85 | 58.6 | 73.6 | 79.4 | 87.9 |
| Td | 15.4 | 3 | 30.2 | 6 | 82.8 | 15 | 55.9 | 5.8 | 75.7 | 6.3 |
| Tp | 2.9 | 14.6 | 3.8 | 27.1 | 4.5 | 69.9 | 2.8 | 67.8 | 3.7 | 81.7 |

The haze is a value indicating the degree of cloudiness, and the smaller the value, the higher the transparency, and the larger the value, the higher the degree of cloudiness. The normal mode light control film becomes opaque when no voltage is applied to the light control layer, and becomes transparent when the voltage is applied to the light control layer. The haze of the sample D, the sample E, and the sample F according to the comparative examples is lower when the voltage is applied than when the voltage is not applied, and thus, it is shown that the degree of cloudiness becomes low (substantially transparent) when the voltage is applied. It was also confirmed that the haze of the sample B and the sample C as the examples, became lower when the voltage was applied than in the state where the voltage was not applied. That is, it was confirmed that the degree of cloudiness of the sample B and the sample C becomes low (substantially transparent) when the voltage is applied. Further, it was confirmed that aspects of changes in the total light transmittance (Tt), the diffusion transmittance (Td), and the parallel transmittance (Tp) are also the same in the sample B and sample C as the examples and the sample D, sample E and sample F as the comparative examples. Thus, it was confirmed that the light control film 10 in which the first electrode layer 12 is the conductive DLC has the same light control function as the light control film in the related art in which the electrode layer is the ITO.

### (Confirmation of Heat Shielding Function)

Infrared rays in the wavelength range of 800 nm to 2000 nm are electromagnetic waves that cause a “feeling of heat” and a “feeling of burning”. Thus, if the transmittance of the infrared rays in this wavelength range can be lowered, the light control film 10 can be provided with a heat shielding function. The inventors performed spectroscopic measurements of the sample A, the sample B and the sample C according to the examples and a sample G and a sample H according to the comparative examples in order to confirm the heat shielding function. The sample G is a sample in which the ITO is applied to the electrode layer and a polyethylene terephthalate is applied to the base material layer. The sample H is a sample in which the ITO is applied to the electrode layer and the polyimide is applied to the base material layer.

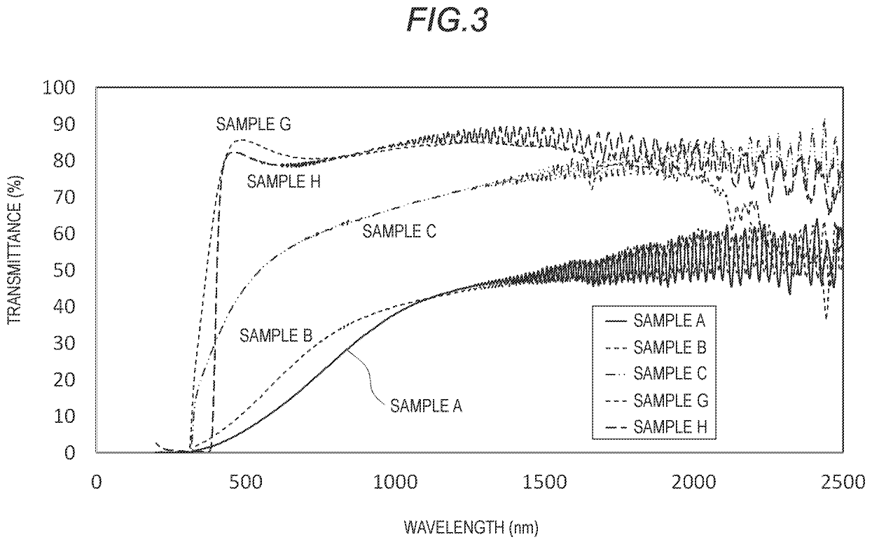

FIG. 3 is a graph showing results of spectroscopic measurements. As shown in FIG. 3, the transmittance of the sample G and the sample H as the comparative examples in the wavelength range of 800 nm to 1600 nm are more than 80%, and the transmittance in the wavelength range of 1600 nm to 2000 nm is 70 to 90%. On the contrary, the transmittance of the sample A and the sample B in the wavelength range of 800 nm to 2000 nm as the examples was about 60% or less, which was lower than the transmittance of the sample G and the sample H as the comparative examples in the same wavelength range. The transmittance of the sample C in the wavelength range of 800 nm to 1600 nm was less than 80%, which was lower than the transmittance of the sample G and the sample H in the same wavelength range. As described above, according to the examples, it was confirmed that the effect of blocking the infrared rays in the wavelength range of 800 nm to 2000 nm, which is the cause of the “feeling of heat” and the “feeling of burning”, is higher than the effect of blocking of the comparative examples. Thus, according to the examples, it was confirmed that the light control film 10 can have the heat shielding function without using a heat shield film separate from the base material layer and the electrode layer.

### (Confirmation of Difficulty in Peeling)

For the formation of the first electric power feeding unit 16, a part of the light control layer 11 stacked on the first electrode layer 12 is wiped off with the cloth or the like impregnated with a solvent to expose a part of the first electrode layer 12. In this case, when a bond strength between the first electrode layer 12 and the first base material layer 14 is weak, the first electrode layer 12 may be peeled off from the first base material layer 14, and the first electric power feeding unit 16 may not be formed.

The inventors conducted experiments to confirm the difficulty of peeling off the conductive DLC layer (first electrode layer 12) on a sample I according to the examples and samples J and K according to the comparative examples. The sample I is a sample corresponding to the sample B and including a polyimide film (first base material layer 14) and a conductive DLC layer formed on the surface of the sample I. The sample J is a sample including a polyimide film as a base material layer and an ITO layer as an electrode layer formed on the surface of the sample J. The sample K is a sample including a polyethylene terephthalate film as a base material layer and an ITO layer as an electrode layer formed on the surface of the sample K. The surfaces of the samples were rubbed with the cloth impregnated with the organic solvent, and changes in sheet resistance between the conductive DLC layer and the ITO layer were measured. Acetone and ethanol were used as the organic solvents. A polyester cloth was used as the cloth for rubbing the surfaces of the samples. The load for rubbing was 1 kgf/cm². The four point probe method was used to measure the sheet resistance.

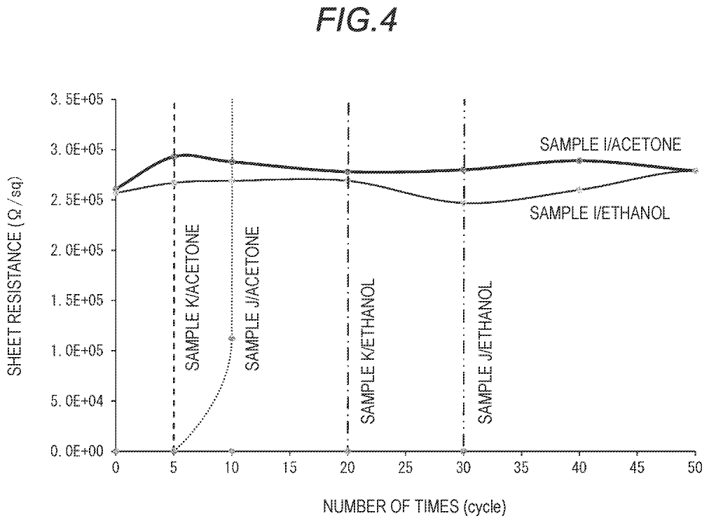

FIG. 4 is a graph showing experiment results for confirming the difficulty of peeling off the conductive DLC layer. The horizontal axis of the graph is the number of times of rubbing (cycle), and the vertical axis is the sheet resistance. As shown in FIG. 4, regarding the sample J according to the comparative example, in the experiment using acetone as the organic solvent, the sheet resistance increased sharply after 10 cycles, and in the experiment using ethanol as the organic solvent, the sheet resistance increased sharply after 30 cycles. Regarding the sample K according to the comparative example, in the experiment using acetone as the organic solvent, the sheet resistance increased sharply after 5 cycles, and in the experiment using ethanol as the organic solvent, the sheet resistance increased sharply after 20 cycles. The sharp increases in sheet resistance are considered to indicate the peeling of the ITO. As described above, it was confirmed that the ITO layer was easily peeled off from the base material layer. In response to this, the sheet resistance of the sample I according to the example remained in a range of 2.5×10⁵ to 3.0×10⁵ Ω/sq regardless of the type of organic solvent and the number of times of rubbing (cycle). As described above, it was confirmed that the conductive DLC layer is difficult to be peeled off from the base material layer.

Although the embodiment disclosed here has been described above, this disclosure is not limited to the above embodiment. Various modifications can be made to this disclosure without departing from the spirit of this disclosure, and such modifications are also included in the technical scope of the present disclosure.

For example, in the above embodiment, the structure in which the polymer-dispersed liquid crystal is applied to the light control layer 11 is shown, but the light control layer 11 is not limited to the polymer-dispersed liquid crystal. Various known liquid crystals can be applied to the light control layer 11. Further, in the above embodiment, the light control layer 11 is shown in which the light transmittance is higher when the voltage is applied as compared with the state where no voltage is applied, but the light control layer 11 is not limited to such a structure. For example, the light control layer 11 may be substantially transparent when no voltage is applied, and the light transmittance may be lowered when the voltage is applied. That is, the reverse mode liquid crystal may be applied to the light control layer 11.

In the above embodiment, the structure in which the polyethylene terephthalate film is applied to the first base material layer 14 and the second base material layer 15 is shown, but the first base material layer 14 and the second base material layer 15 are not limited to polyethylene terephthalate. The first base material layer 14 and the second base material layer 15 may be any materials which are transparent or translucent and can form the electrode layer on the surfaces of the materials (which can withstand the step of forming the electrode layer).

According to an aspect of this disclosure, a light control film includes:

a light control layer containing a material in which transmittance of electromagnetic waves changes when a voltage is applied;

a first electrode layer and a second electrode layer that are respectively stacked on both sides of the light control layer and are configured such that the voltage is applicable to the light control layer;

a substantially transparent first base material layer that is stacked on a side of the first electrode layer opposite to the light control layer and supports the first electrode layer; and

a substantially transparent second base material layer that is stacked on a side of the second electrode layer opposite to the light control layer and supports the second electrode layer, in which

at least one of the first electrode layer and the second electrode layer is a conductive DLC layer.

In this disclosure, the “light” includes not only visible light but also electromagnetic waves in wavelength ranges other than visible light such as infrared rays.

The DLC layer has a lower infrared transmittance than metal materials such as ITO used as related-art electrode layers. Thus, by applying a conductive DLC layer to one or both of the first electrode layer and the second electrode layer, it is possible to provide one or both of the first electrode layer and the second electrode layer with a heat shielding function. In other words, the light control film may be provided with the heat shielding function without attaching a heat shielding film (in other words, without using the separate heat shielding film). The DLC is dark brown, and color density changes depending on the thickness. Thus, by applying a layer of the DLC having a predetermined thickness to the first electrode layer and the second electrode layer, it is possible to provide the light control film with a color adjusting function without attaching a colored film.

In the above configuration, the thickness of the conductive DLC layer may be 0.05 μm or more and 0.3 μm or less.

With this configuration, the parallel transmittance may be set to about 3% to about 40%. Thus, it is possible to provide a light control film suitable for, for example, shaded outdoor daylighting glass, specifically, a sunroof glass or the like.

In the above configuration, the thickness of the conductive DLC layer may be more than 0.3 μm and 0.5 μm or less.

With this configuration, the parallel transmittance may be set to about 1% to about 3%. Thus, it is possible to provide a light control film suitable for outdoor daylighting glass without a shade.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A light control film comprising:
a light control layer containing a material in which transmittance of electromagnetic waves changes when a voltage is applied;
a first electrode layer and a second electrode layer that are respectively stacked on both sides of the light control layer and are configured such that the voltage is applicable to the light control layer;
a substantially transparent first base material layer that is stacked on a side of the first electrode layer opposite to the light control layer and supports the first electrode layer; and
a substantially transparent second base material layer that is stacked on a side of the second electrode layer opposite to the light control layer and supports the second electrode layer, wherein
at least one of the first electrode layer and the second electrode layer is a conductive DLC layer.

2. The light control film according to claim 1, wherein
a thickness of the conductive DLC layer is 0.05 μm or more and 0.3 μm or less.

3. The light control film according to claim 1, wherein
the thickness of the conductive DLC layer is more than 0.3 μm and 0.5 μm or less.
